(19) United States
(12) Patent Application Publication
(10) Pub. No.: US 2026/0186810 A1
(43) Pub. Date: Jul. 2, 2026

(54) COMPUTING DEVICE AND METHODS PROVIDING VIRTUAL COMPUTING SESSION VOLUME ADJUSTMENT FEATURES

(71) Applicant: Citrix Systems, Inc., FT. LAUDERDALE, FL (US)

(72) Inventors: Jing Zhao, Nanjing (CN); Qiaofei Zhu, Nanjing (CN); Ke Xu, Nanjing (CN); Zongpeng Qiao, Nanjing (CN)

(21) Appl. No.: 18/868,335

(22) PCT Filed: Sep. 21, 2022
(86) PCT No.: PCT/CN2022/120066

§ 371 Date: Dec. 3, 2024

(51) Int. Cl. G06F 9/455

(52) U.S. Cl. CPC G06F 9/45558

(57) ABSTRACT

A computing device may include a memory and a processor cooperating with the memory to provide at least one client device with access to a virtual computing session having a session volume level associated therewith, and receive audio playback data from the at least one client device including an audio device type and a background noise level associated with the at least one client device. The processor may further change the session volume level responsive to the received audio playback data and historical session volume levels for corresponding background noise levels and audio device types associated with the at least one client device.

### RELATED APPLICATIONS

This application claims priority to and is a national stage filing under 35 U.S.C. § 371 of International Patent Cooperation Treaty (PCT) application number PCT/CN2022/120066 (filed Sep. 21, 2022). All patents and applications listed in this paragraph are incorporated here by reference in its entirety.

### BACKGROUND

Web applications or apps are software programs that run on a server and are accessed remotely by client devices through a Web browser. That is, while Web applications have a similar functionality to native applications installed directly on the client device, Web applications are instead installed and run on the server, and only the browser application is installed on the client device. Although in some implementations, a hosted browser running on a virtualization server may be used to access Web applications as well.

One advantage of using Web applications is that this allows client devices to run numerous different applications without having to install all of these applications on the client device. This may be particularly beneficial for thin client devices, which typically have reduced memory and processing capabilities. Moreover, updating Web applications may be easier than native applications, as updating is done at the server level rather than having to push out updates to numerous different types of client devices.

Software as a Service (SaaS) is a Web application licensing and delivery model in which applications are delivered remotely as a web-based service, typically on a subscription basis. SaaS is used for delivering several different types of business (and other) applications, including office, database, accounting, customer relation management (CRM), etc.

### SUMMARY

A computing device may include a memory and a processor cooperating with the memory to provide at least one client device with access to a virtual computing session having a session volume level associated therewith, and receive audio playback data from the at least one client device including an audio device type and a background noise level associated with the at least one client device. The processor may further change the session volume level responsive to the received audio playback data and historical session volume levels for corresponding background noise levels and audio device types associated with the at least one client device.

In an example implementation, the processor may be configured to change the session volume level responsive to a change in the audio device type. In accordance with another example implementation, the processor may be configured to change the session volume level responsive to the at least one client computing device accessing the virtual computing session from a different location.

In some embodiments, the processor may be further configured to change the session volume level by switching the session volume level to a first level, and then fading the session volume level in to a second level higher than the first level. In an example implementation, the historical session volume levels may also correspond to different locations. Furthermore, the processor may be further configured to communicate with a volume analysis service to store and update the historical session volume levels in some implementations. In an example embodiment, the at least one client device may comprise a first client device at a first location and a second client device at a second location different than the first location, and the processor may be configured to receive the audio playback data from the first client device and change the session volume level at the second client device.

A related method may include, at a computing device, providing at least one client device with access to a virtual computing session having a session volume level associated therewith, receiving audio playback data from the at least one client device including an audio device type and a background noise level associated with the at least one client device. The method may further include changing the session volume level responsive to the received audio playback data and historical session volume levels for corresponding background noise levels and audio device types associated with the at least one client device.

A related non-transitory computer-readable medium may have computer-executable instructions for causing a computing device to perform steps including providing at least one client device with access to a virtual computing session having a session volume level associated therewith. The steps may further include receiving audio playback data from the at least one client device including an audio device type and a background noise level associated with the at least one client device, and changing the session volume level responsive to the received audio playback data and historical session volume levels for corresponding background noise levels and audio device types associated with the at least one client device.

### BRIEF DESCRIPTION OF THE DRAWINGS

FIG. 1 is a schematic block diagram of a network environment of computing devices in which various aspects of the disclosure may be implemented.

FIG. 2 is a schematic block diagram of a computing device useful for practicing an embodiment of the client machines or the remote machines illustrated in FIG. 1.

FIG. 3 is a schematic block diagram of a cloud computing environment in which various aspects of the disclosure may be implemented.

FIG. 4 is a schematic block diagram of desktop, mobile and web-based devices operating a workspace app in which various aspects of the disclosure may be implemented.

FIG. 5 is a schematic block diagram of a workspace network environment of computing devices in which various aspects of the disclosure may be implemented.

FIG. 6 is a schematic block diagram of a computing device providing virtual computing session volume adjustment features in accordance with an example embodiment.

FIG. 7 is a schematic block diagram of an example virtual computing environment in which the computing device may be implemented.

FIGS. 8A and 8B are a series of schematic block diagrams illustrating a session volume adjustment in an example implementation.

FIGS. 9A and 9B are a series of schematic block diagrams illustrating a session volume adjustment in accordance with another example implementation.

FIGS. 10, 11A, and 11B are flow diagrams illustrating method aspects associated with the computing device of FIG. 6 in example implementations.

### DETAILED DESCRIPTION

One particular virtual computing platform, Citrix Workspace, supports a hybrid mode which allows switching the user's workspace smoothly between different devices and from different locations. By way of example, the different working locations may include home, office, café, airport, train, etc. Supported client devices include PCs, laptops, mobile phones, etc., which may in turn be used with different types of audio devices such as loudspeakers, voice boxes, headphones, etc. However, the ability to switch between different types of audio devices and locations can prove problematic when trying to set a suitable volume level for virtual computing sessions. For example, when switching working places from home to office (both of with are using loudspeakers), the audio volume that is set for the virtual computing session at home may be so high that when the user logs into the virtual computing session at work and the loudspeaker plays audio in the quiet office, it disturbs others and may cause embarrassment to the user. In another example, when switching between different audio devices, e.g., from a loudspeaker to headphones, the audio volume set previously for the loudspeaker may be so loud that it causes discomfort or even harms the user's hearing through the headphones. Yet, it is difficult for users to recognize or remember the need to turn down the audio volume before putting on the headphones.

The approach set forth herein advantageously helps overcome these technical problems through the use of a computing device which automatically adjusts audio volume when switching between different audio devices and/or locations while accessing virtual computing sessions. Generally speaking, the computing device may utilize three factors as input variables to determine a new, appropriate session audio volume upon changing of audio devices and/or locations. These include the audio device type which is being used (which may be positively correlative), the background noise volume at the working place (which may be collected through the temporary use of an associated microphone, for example), and the user's preferred audio volume in similar environments with different background noise volumes.

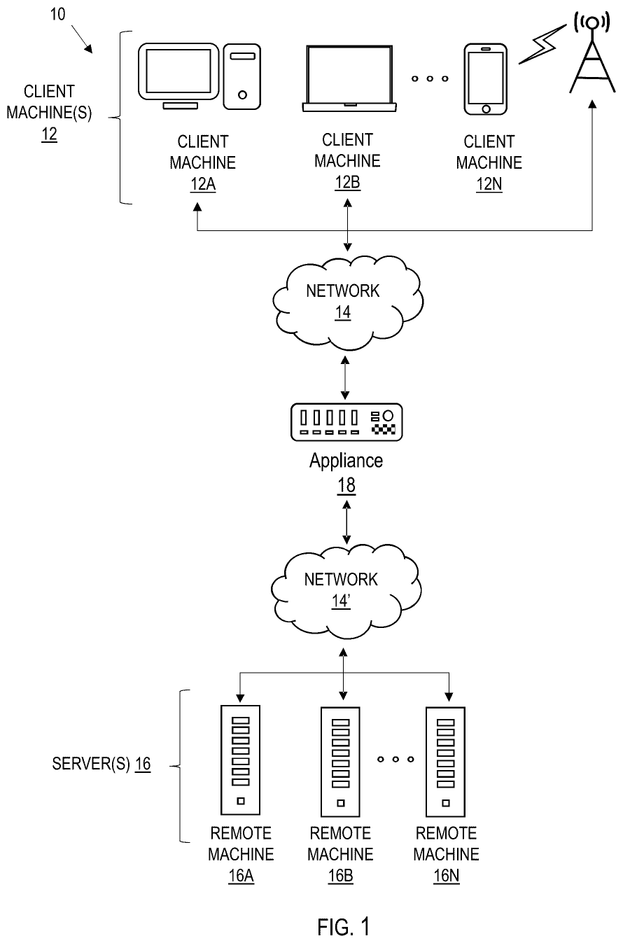

Referring initially to FIG. 1, a non-limiting network environment 10 in which various aspects of the disclosure may be implemented includes one or more client machines 12A-12N, one or more remote machines 16A-16N, one or more networks 14, 14′, and one or more appliances 18 installed within the computing environment 10. The client machines 12A-12N communicate with the remote machines 16A-16N via the networks 14, 14′.

In some embodiments, the client machines 12A-12N communicate with the remote machines 16A-16N via an intermediary appliance 18. The illustrated appliance 18 is positioned between the networks 14, 14′ and may also be referred to as a network interface or gateway. In some embodiments, the appliance 108 may operate as an application delivery controller (ADC) to provide clients with access to business applications and other data deployed in a data center, the cloud, or delivered as Software as a Service (SaaS) across a range of client devices, and/or provide other functionality such as load balancing, etc. In some embodiments, multiple appliances 18 may be used, and the appliance(s) 18 may be deployed as part of the network 14 and/or 14′.

The client machines 12A-12N may be generally referred to as client machines 12, local machines 12, clients 12, client nodes 12, client computers 12, client devices 12, computing devices 12, endpoints 12, or endpoint nodes 12. The remote machines 16A-16N may be generally referred to as servers 16 or a server farm 16. In some embodiments, a client device 12 may have the capacity to function as both a client node seeking access to resources provided by a server 16 and as a server 16 providing access to hosted resources for other client devices 12A-12N. The networks 14, 14′ may be generally referred to as a network 14. The networks 14 may be configured in any combination of wired and wireless networks.

A server 16 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 16 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 16 may execute a remote presentation services program or other program that uses a thin-client or a remote-display protocol to capture display output generated by an application executing on a server 16 and transmit the application display output to a client device 12.

In yet other embodiments, a server 16 may execute a virtual machine providing, to a user of a client device 12, access to a computing environment. The client device 12 may be a virtual machine. The virtual machine may be managed by, for example, a hypervisor, a virtual machine manager (VMM), or any other hardware virtualization technique within the server 16.

In some embodiments, the network 14 may be: a local-area network (LAN); a metropolitan area network (MAN); a wide area network (WAN); a primary public network 14; and a primary private network 14. Additional embodiments may include a network 14 of mobile telephone networks that use various protocols to communicate among mobile devices. For short range communications within a wireless local-area network (WLAN), the protocols may include 802.11, Bluetooth, and Near Field Communication (NFC).

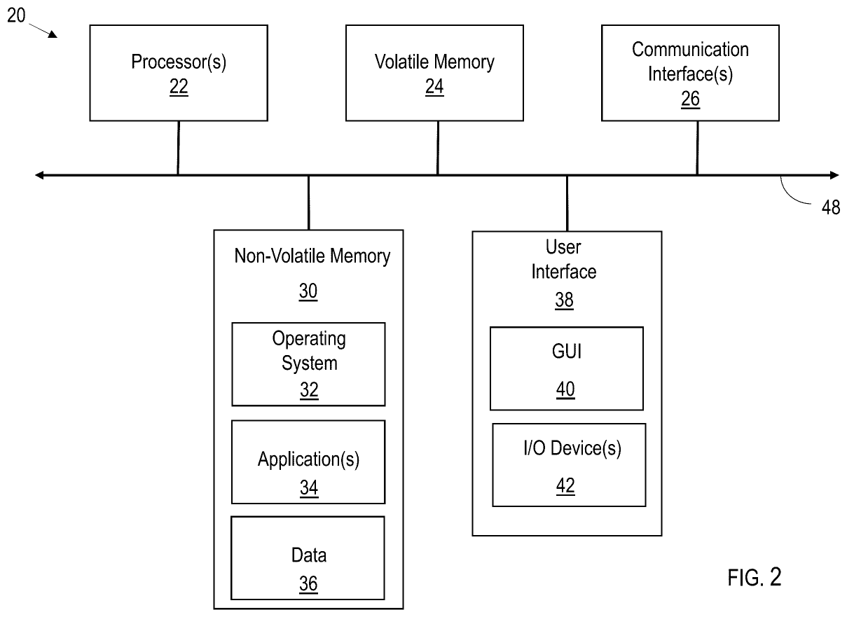

FIG. 2 depicts a block diagram of a computing device 20 useful for practicing an embodiment of client devices 12, appliances 18 and/or servers 16. The computing device 20 includes one or more processors 22, volatile memory 24 (e.g., random access memory (RAM)), non-volatile memory 30, user interface (UI) 38, one or more communications interfaces 26, and a communications bus 48.

The non-volatile memory 30 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 38 may include a graphical user interface (GUI) 40 (e.g., a touchscreen, a display, etc.) and one or more input/output (I/O) devices 42 (e.g., a mouse, a keyboard, a microphone, one or more speakers, one or more cameras, one or more biometric scanners, one or more environmental sensors, and one or more accelerometers, etc.).

The non-volatile memory 30 stores an operating system 32, one or more applications 34, and data 36 such that, for example, computer instructions of the operating system 32 and/or the applications 34 are executed by processor(s) 22 out of the volatile memory 24. In some embodiments, the volatile memory 24 may include one or more types of RAM and/or a cache memory that may offer a faster response time than a main memory. Data may be entered using an input device of the GUI 40 or received from the I/O device(s) 42. Various elements of the computer 20 may communicate via the communications bus 48.

The illustrated computing device 20 is shown merely as an example client device or server, and may be implemented by any computing or processing environment with any type of machine or set of machines that may have suitable hardware and/or software capable of operating as described herein.

The processor(s) 22 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

The processor 22 may be analog, digital or mixed-signal. In some embodiments, the processor 22 may be one or more physical processors, or one or more virtual (e.g., remotely located or cloud) processors. A processor including multiple processor cores and/or multiple processors may provide functionality for parallel, simultaneous execution of instructions or for parallel, simultaneous execution of one instruction on more than one piece of data.

The communications interfaces 26 may include one or more interfaces to enable the computing device 20 to access a computer network such as a Local Area Network (LAN), a Wide Area Network (WAN), a Personal Area Network (PAN), or the Internet through a variety of wired and/or wireless connections, including cellular connections.

In described embodiments, the computing device 20 may execute an application on behalf of a user of a client device. For example, the computing device 20 may execute one or more virtual machines managed by a hypervisor. Each virtual machine may provide an execution session within which applications execute on behalf of a user or a client device, such as a hosted desktop session. The computing device 20 may also execute a terminal services session to provide a hosted desktop environment. The computing device 20 may provide access to a remote computing environment including one or more applications, one or more desktop applications, and one or more desktop sessions in which one or more applications may execute.

An example virtualization server 16 may be implemented using Citrix Hypervisor provided by Citrix Systems, Inc., of Fort Lauderdale, Florida (“Citrix Systems”). Virtual app and desktop sessions may further be provided by Citrix Virtual Apps and Desktops (CVAD), also from Citrix Systems. Citrix Virtual Apps and Desktops is an application virtualization solution that enhances productivity with universal access to virtual sessions including virtual app, desktop, and data sessions from any device, plus the option to implement a scalable VDI solution. Virtual sessions may further include Software as a Service (SaaS) and Desktop as a Service (DaaS) sessions, for example.

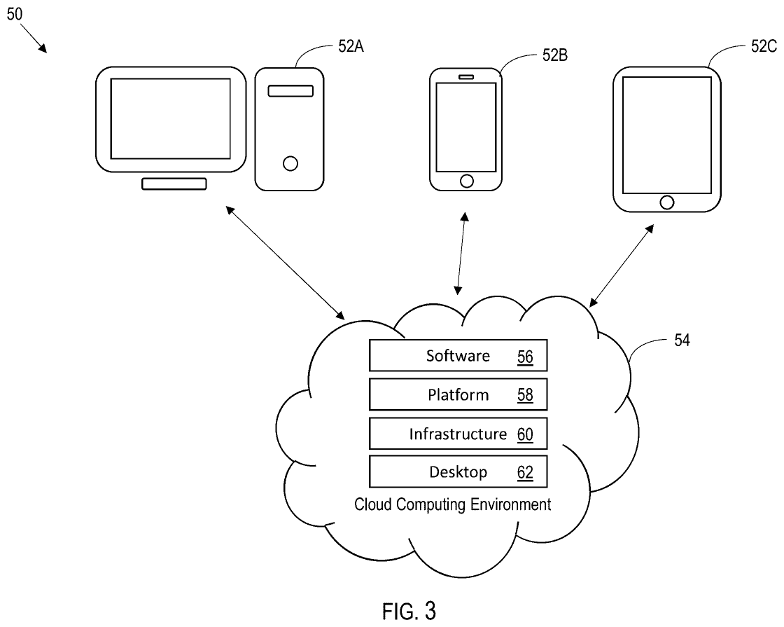

Referring to FIG. 3, a cloud computing environment 50 is depicted, which may also be referred to as a cloud environment, cloud computing or cloud network. The cloud computing environment 50 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 50, one or more clients 52A-52C (such as those described above) are in communication with a cloud network 54. The cloud network 54 may include backend platforms, e.g., servers, storage, server farms or data centers. The users or clients 52A-52C can correspond to a single organization/tenant or multiple organizations/tenants. More particularly, in one example implementation the cloud computing environment 50 may provide a private cloud serving a single organization (e.g., enterprise cloud). In another example, the cloud computing environment 50 may provide a community or public cloud serving multiple organizations/tenants. In still further embodiments, the cloud computing environment 50 may provide a hybrid cloud that is a combination of a public cloud and a private cloud. Public clouds may include public servers that are maintained by third parties to the clients 52A-52C or the enterprise/tenant. The servers may be located off-site in remote geographical locations or otherwise.

The cloud computing environment 50 can provide resource pooling to serve multiple users via clients 52A-52C through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 50 can provide on-demand self-service to unilaterally provision computing capabilities (e.g., server time, network storage) across a network for multiple clients 52A-52C. The cloud computing environment 50 can provide an elasticity to dynamically scale out or scale in responsive to different demands from one or more clients 52. In some embodiments, the computing environment 50 can include or provide monitoring services to monitor, control and/or generate reports corresponding to the provided shared services and resources.

In some embodiments, the cloud computing environment 50 may provide cloud-based delivery of different types of cloud computing services, such as Software as a service (SaaS) 56, Platform as a Service (PaaS) 58, Infrastructure as a Service (IaaS) 60, and Desktop as a Service (DaaS) 62, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g., DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud is one example of a DaaS delivery platform. DaaS delivery platforms may be hosted on a public cloud computing infrastructure such as AZURE CLOUD from Microsoft Corporation of Redmond, Washington (herein “Azure”), or AMAZON WEB SERVICES provided by Amazon.com, Inc., of Seattle, Washington (herein “AWS”), for example. In the case of Citrix Cloud, Citrix Workspace app (CWA) may be used as a single-entry point for bringing apps, files and desktops together (whether on-premises or in the cloud) to deliver a unified experience.

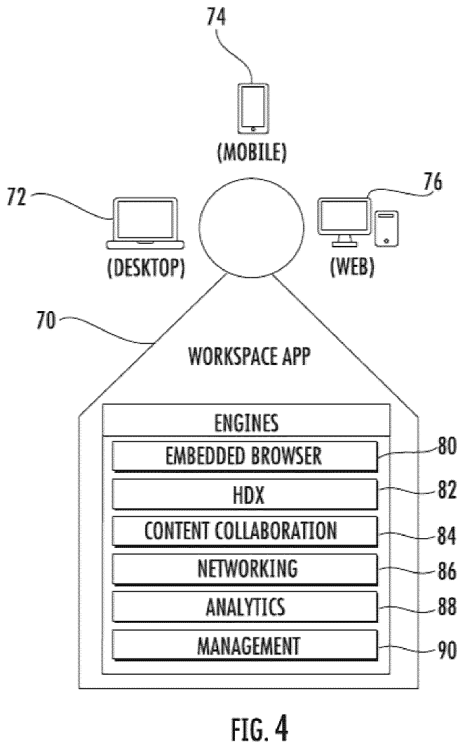

The unified experience provided by the Citrix Workspace app will now be discussed in greater detail with reference to FIG. 4. The Citrix Workspace app will be generally referred to herein as the workspace app 70. The workspace app 70 is how a user gets access to their workspace resources, one category of which is applications. These applications can be SaaS apps, web apps or virtual apps. The workspace app 70 also gives users access to their desktops, which may be a local desktop or a virtual desktop. Further, the workspace app 70 gives users access to their files and data, which may be stored in numerous repositories. The files and data may be hosted on Citrix ShareFile, hosted on an on-premises network file server, or hosted in some other cloud storage provider, such as Microsoft OneDrive or Google Drive Box, for example.

To provide a unified experience, all of the resources a user requires may be located and accessible from the workspace app 70. The workspace app 70 is provided in different versions. One version of the workspace app 70 is an installed application for desktops 72, which may be based on Windows, Mac or Linux platforms. A second version of the workspace app 70 is an installed application for mobile devices 74, which may be based on iOS or Android platforms. A third version of the workspace app 70 uses a hypertext markup language (HTML) browser to provide a user access to their workspace environment. The web version of the workspace app 70 is used when a user does not want to install the workspace app or does not have the rights to install the workspace app, such as when operating a public kiosk 76.

Each of these different versions of the workspace app 70 may advantageously provide the same user experience. This advantageously allows a user to move from client device 72 to client device 74 to client device 76 in different platforms and still receive the same user experience for their workspace. The client devices 72, 74 and 76 are referred to as endpoints.

As noted above, the workspace app 70 supports Windows, Mac, Linux, iOS, and Android platforms as well as platforms with an HTML browser (HTML5). The workspace app 70 incorporates multiple engines 80-90 allowing users access to numerous types of app and data resources. Each engine 80-90 optimizes the user experience for a particular resource. Each engine 80-90 also provides an organization or enterprise with insights into user activities and potential security threats.

An embedded browser engine 80 keeps SaaS and web apps contained within the workspace app 70 instead of launching them on a locally installed and unmanaged browser. With the embedded browser, the workspace app 70 is able to intercept user-selected hyperlinks in SaaS and web apps and request a risk analysis before approving, denying, or isolating access.

A high definition experience (HDX) engine 82 establishes connections to virtual browsers, virtual apps and desktop sessions running on either Windows or Linux operating systems. With the HDX engine 82, Windows and Linux resources run remotely, while the display remains local, on the endpoint. To provide the best possible user experience, the HDX engine 82 utilizes different virtual channels to adapt to changing network conditions and application requirements. To overcome high-latency or high-packet loss networks, the HDX engine 82 automatically implements optimized transport protocols and greater compression algorithms. Each algorithm is optimized for a certain type of display, such as video, images, or text. The HDX engine 82 identifies these types of resources in an application and applies the most appropriate algorithm to that section of the screen.

For many users, a workspace centers on data. A content collaboration engine 84 allows users to integrate all data into the workspace, whether that data lives on-premises or in the cloud. The content collaboration engine 84 allows administrators and users to create a set of connectors to corporate and user-specific data storage locations. This can include OneDrive, Dropbox, and on-premises network file shares, for example. Users can maintain files in multiple repositories and allow the workspace app 70 to consolidate them into a single, personalized library.

A networking engine 86 identifies whether or not an endpoint or an app on the endpoint requires network connectivity to a secured backend resource. The networking engine 86 can automatically establish a full VPN tunnel for the entire endpoint device, or it can create an app-specific p-VPN connection. A p-VPN defines what backend resources an application and an endpoint device can access, thus protecting the backend infrastructure. In many instances, certain user activities benefit from unique network-based optimizations. If the user requests a file copy, the workspace app 70 can automatically utilize multiple network connections simultaneously to complete the activity faster. If the user initiates a VoIP call, the workspace app 70 improves its quality by duplicating the call across multiple network connections. The networking engine 86 uses only the packets that arrive first.

An analytics engine 88 reports on the user's device, location and behavior, where cloud-based services identify any potential anomalies that might be the result of a stolen device, a hacked identity or a user who is preparing to leave the company. The information gathered by the analytics engine 88 protects company assets by automatically implementing countermeasures.

A management engine 90 keeps the workspace app 70 current. This not only provides users with the latest capabilities, but also includes extra security enhancements. The workspace app 70 includes an auto-update service that routinely checks and automatically deploys updates based on customizable policies.

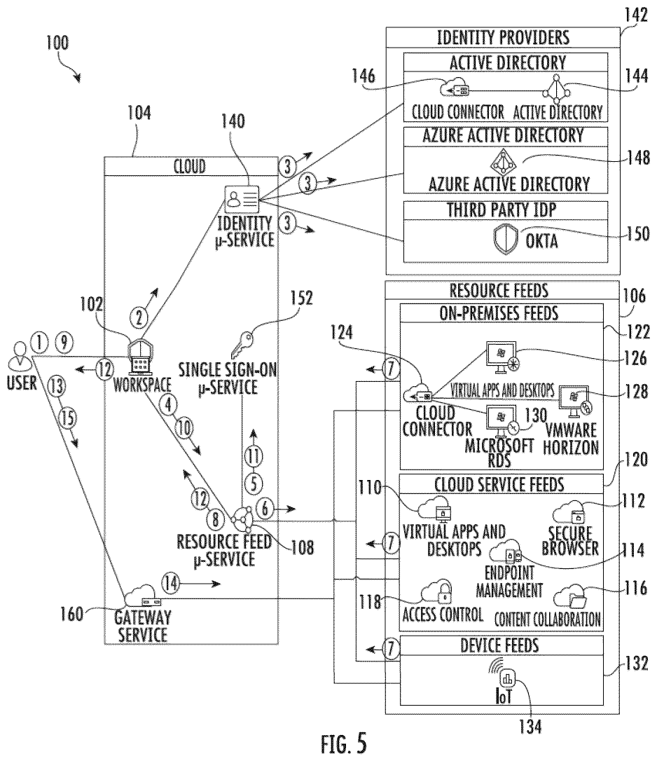

Referring now to FIG. 5, a workspace network environment 100 providing a unified experience to a user based on the workspace app 70 will be discussed. The desktop, mobile and web versions of the workspace app 70 all communicate with the workspace experience service 102 running within the Cloud 104. The workspace experience service 102 then pulls in all the different resource feeds 16 via a resource feed micro-service 108. That is, all the different resources from other services running in the Cloud 104 are pulled in by the resource feed micro-service 108. The different services may include a virtual apps and desktop service 110, a secure browser service 112, an endpoint management service 114, a content collaboration service 116, and an access control service 118. Any service that an organization or enterprise subscribes to are automatically pulled into the workspace experience service 102 and delivered to the user's workspace app 70.

In addition to cloud feeds 120, the resource feed micro-service 108 can pull in on-premises feeds 122. A cloud connector 124 is used to provide virtual apps and desktop deployments that are running in an on-premises data center. Desktop virtualization may be provided by Citrix virtual apps and desktops 126, Microsoft RDS 128 or VMware Horizon 130, for example. In addition to cloud feeds 120 and on-premises feeds 122, device feeds 132 from Internet of Thing (IoT) devices 134, for example, may be pulled in by the resource feed micro-service 108. Site aggregation is used to tie the different resources into the user's overall workspace experience.

The cloud feeds 120, on-premises feeds 122 and device feeds 132 each provides the user's workspace experience with a different and unique type of application. The workspace experience can support local apps, SaaS apps, virtual apps, and desktops browser apps, as well as storage apps. As the feeds continue to increase and expand, the workspace experience is able to include additional resources in the user's overall workspace. This means a user will be able to get to every single application that they need access to.

Still referring to the workspace network environment 20, a series of events will be described on how a unified experience is provided to a user. The unified experience starts with the user using the workspace app 70 to connect to the workspace experience service 102 running within the Cloud 104, and presenting their identity (event 1). The identity includes a username and password, for example.

The workspace experience service 102 forwards the user's identity to an identity micro-service 140 within the Cloud 104 (event 2). The identity micro-service 140 authenticates the user to the correct identity provider 142 (event 3) based on the organization's workspace configuration. Authentication may be based on an on-premises active directory 144 that requires the deployment of a cloud connector 146. Authentication may also be based on Azure Active Directory 148 or even a third-party identity provider 150, such as Citrix ADC or Okta, for example.

Once authorized, the workspace experience service 102 requests a list of authorized resources (event 4) from the resource feed micro-service 108. For each configured resource feed 106, the resource feed micro-service 108 requests an identity token (event 5) from the single-sign micro-service 152.

The resource feed specific identity token is passed to each resource's point of authentication (event 6). On-premises resources 122 are contacted through the Cloud Connector 124. Each resource feed 106 replies with a list of resources authorized for the respective identity (event 7).

The resource feed micro-service 108 aggregates all items from the different resource feeds 106 and forwards (event 8) to the workspace experience service 102. The user selects a resource from the workspace experience service 102 (event 9).

The workspace experience service 102 forwards the request to the resource feed micro-service 108 (event 10). The resource feed micro-service 108 requests an identity token from the single sign-on micro-service 152 (event 11). The user's identity token is sent to the workspace experience service 102 (event 12) where a launch ticket is generated and sent to the user.

The user initiates a secure session to a gateway service 160 and presents the launch ticket (event 13). The gateway service 160 initiates a secure session to the appropriate resource feed 106 and presents the identity token to seamlessly authenticate the user (event 14). Once the session initializes, the user is able to utilize the resource (event 15). Having an entire workspace delivered through a single access point or application advantageously improves productivity and streamlines common workflows for the user.

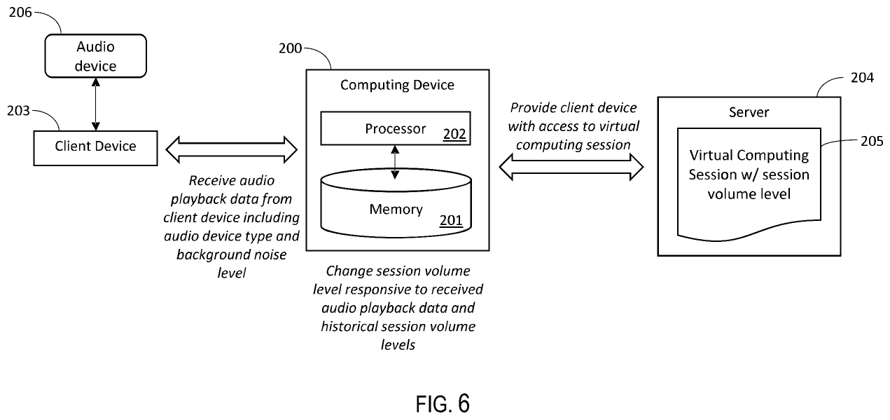

Turning now to FIG. 6, a computing device 200 illustratively includes a memory 201 and a processor 202 cooperating with the memory to provide a client device(s) 203 with access to a virtual computing session 205 (e.g., from a server 204) having a session volume level associated therewith. By way of example, the virtual computing session 205 may be a virtual desktop/app, Software as a Service (SaaS) session, Desktop as a Service (DaaS) session, etc. The processor 202 further receives audio playback data from the client device 203 including an audio device 206 type, and a background noise level associated with the client device. Moreover, the processor 202 may further change the session volume level responsive to the received audio playback data, as will be discussed further below.

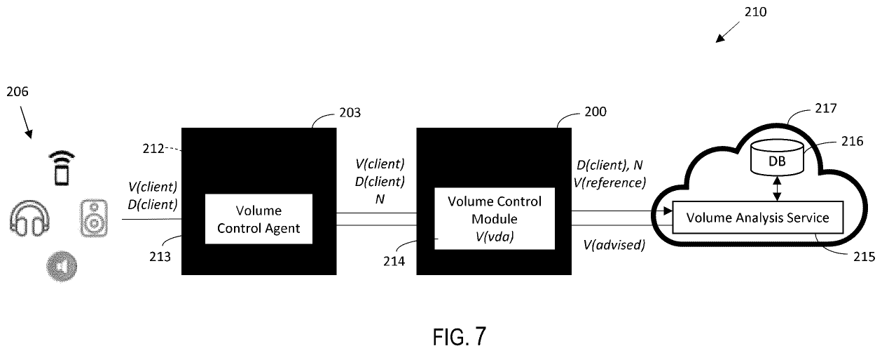

Referring additionally to FIG. 7, an example virtual computing system 210 in which the computing device 200 may be implemented is now described. Here, the computing device 200 is implemented as a Virtual Delivery Agent (VDA) in a Citrix Workspace implementation which communicates with client devices 203 running CWA clients or instances 212, as discussed further above. Moreover, each CWA client 212 includes a volume control agent (VCA) or module 213, which communicates with a volume control module (VCM) 214 at the computing device (VDA) 200. Moreover, the volume control module 214 also communicates with a volume analysis service (VAS) 215 and associated database 216 in a Cloud platform 217 (Citrix Cloud in the present example).

The volume control agent 213 detects any audio device 206 changes, as well as session connect/reconnect events, to identify when volume changes are appropriate to help not only protect users' hearing, but also to avoid embarrassing situations from unintended loud volume bursts. In such instances, the volume control module 214 may temporally turn down the volume level of the virtual computing session to a relatively low starting value (e.g., 20% of the previous value with the prior audio device 206 or at the prior working location), called a protection value. It should be noted that the session volume level is a digital audio output level set for the session, through in some cases users may also have the ability to further manually adjust volume locally with certain audio devices 206 (e.g., a volume knob on a speaker). Furthermore, the volume control agent 213 also temporally collects the background noise volume at the client device 203 as an input source and sends this data to the volume control module 214 for analysis to determine an advised audio volume value.

Furthermore, the volume control module 214 causes the volume control agent 213 to adjust the session volume based upon the audio device type. For example, when the audio device 206 is headphones, the volume may be adapted to a lower level to avoid discomfort or damage to the user's ears. As will be discussed further below, the automatic volume control process involves a fade in, in that it may extend over a period of a few seconds and slowly turn up the session volume from an initial protection value to the final target value, which may help provide a better user experience.

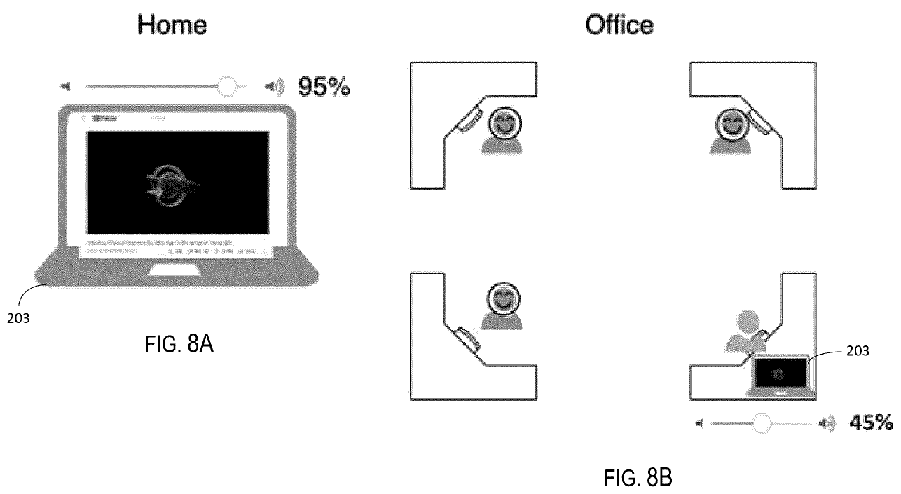

In an example implementation shown in FIGS. 8A and 8B, at a first time (FIG. 8A) when disconnecting from a virtual computing session 205 (e.g., SaaS, DaaS, etc.) at home, the session volume is set to 95%. Here, the user is using a laptop as the client device 203, and is playing audio through the integrated (built-in) laptop speakers. However, when the user returns to his or her office at a later time (FIG. 8B) and reconnects the same laptop to a prior or new virtual computing session 205, the session audio volume is automatically adjusted by the volume control module 214 to 45% to adapt to the new environment. This advantageously helps prevent disturbing others in the office from an overly loud volume playing through the integrated laptop speakers, and any associated embarrassment that the user would otherwise experience.

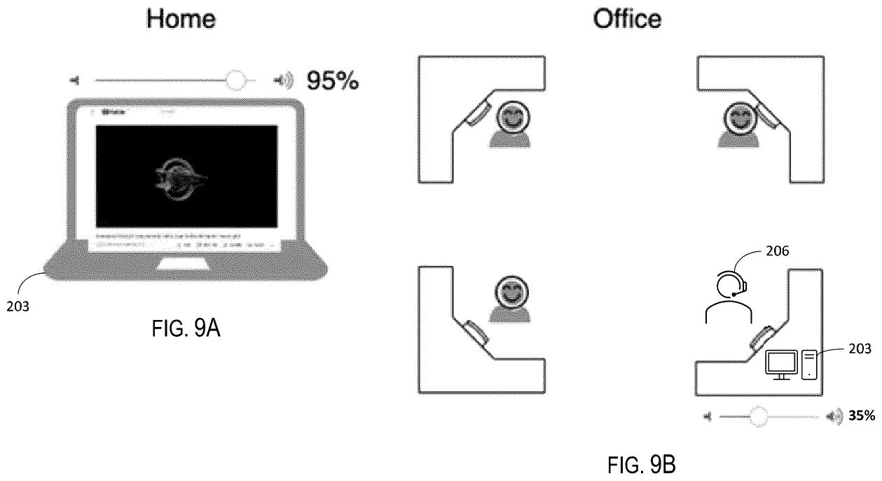

In another similar example shown in FIGS. 9A and 9B, the user switches from the integrated speakers of the laptop at home (FIG. 9A) to a different type of audio device 206 (i.e., headphones) at the office (FIG. 9B). Here again, the volume control agent 213 detects the different type of audio device 206 in use at the office, and also measures background noise at the office (e.g., through a headphone mic or laptop mic, for example) to send to the volume control module 214. The volume control module 214 first turns down the session volume to a protection value (e.g., 15% of the prior session volume level), then slowly fades in or ramps up the session volume to a target value determined based upon an analysis of historical user preference data. Particularly in the case of headphones, this helps avoid discomfort and/or damage to the user's hearing.

In an example implementation, the volume control agent 213 can be integrated into CWA as a new module that may perform one or more functions. One of these functions may include obtaining a current local session volume value of the client V(client) which CWA 212 is using at the client device 203. The volume control agent 213 may further detect the current audio device type for the audio device 206 being used by the client device 203 (e.g., integrated speakers, external speakers, headphones, etc.), denoted as D(client). Furthermore, the volume control agent 213 also detects the noise level in the environment (denoted as N), e.g., with the microphone of the client device(s) 203 that runs the CWA client 212. By way of example, the volume control agent 213 may detect the noise level for a short time at startup, as opposed to monitoring the noise level from the microphone during all working hours or throughout the virtual computing session 205. That is, if there are any noise fluctuations later in the environment, users may manually change the session volume locally at such time. However, in some embodiments a continuous or intermittent/periodic monitoring of background noise may be performed to allow for automated adjustments after startup of the session, if desired.

Other functions performed by the volume control agent 213 may include passing or communicating the values of V(client), N and D(client) to the volume control module 214. After some processing, the volume control module 214 may change the value of V(vda) (i.e., the new target session volume level), which will take effect at the CWA client 213 through a protocol such as Citric Independent Computing Architecture (ICA), although other suitable protocols may be used in different embodiments. Furthermore, if the user manually makes a session volume adjustment after the automatic adjustment at startup at the CWA client 212, the volume control agent 213 may send an updated V(client) value to the volume control module 214 (and, optionally, a corresponding background noise measurement) to calculate a new reference volume, denoted as V(reference).

The volume control module 214 may be integrated as a new module into VDAs (or other virtual delivery devices) and perform various functions. For example, the volume control module 214 may quickly decrease the volume to a protected level (e.g., 20% of the original session volume) to protect users' listening upon sending a re-evaluation request to the volume analysis service 215. In the example implementation, the volume control module 214 also forwards the values of N and D(client) received from the volume control agent 213 to the volume analysis service 215 for further analysis, obtains a calculated result V(advised) from the volume analysis service, and then calculates the new target volume V(vda)=V(advised)/V(client), for example.

As noted above, the volume control module 214 may also gradually fade in or ramp up the session volume to the target value V(vda), which again helps protect the user's hearing and improve user experience. In addition, the volume control module 214, in the case of a manual volume adjustment by the user after the initial automatic adjustment (either at the CWA client 212 or on the VDA 200 side, V(vda) and V(client) will be updated, and a new reference volume V(reference)=V(vda)*V(client), will be sent to the volume analysis service 215 for further analysis.

More particularly, the volume analysis service 215 can be integrated into a cloud platform 217 (Citrix Cloud in the present example) as a service to perform various function. First, the volume analysis service 215 receives N and D(client) from the volume control module 214. Furthermore, it also queries the database 216 for the given user's V̅_{D,N}, which is the average volume on D(client) under a certain noise level N as V(advised). The volume analysis service 215 further sends back V(advised) to the volume control module 214 for further volume control. As noted above, if the user makes a manual volume adjustment after the initial automatic adjustment, the volume analysis service 215 may obtain V(reference) from the volume control module 214 calculate a new V̅_{D,N}, and update the data in the database 216 for the user.

By way of example, the database 216 may be integrated into a cloud computing database architecture as a new scheme which includes a list for adjusting session volume according to different audio devices 206 and with different background noise. For example, for a user johnz, the following Table 1 is maintained in the database 216:

TABLE 1

| Background | Speaker | Headphone |
|---|---|---|
| Noise | Volume | Volume |
| 25 dB | 20% | 10% |
| 40 dB | 30% | 20% |
| 50 dB | 55% | 45% |

The original data stored in the scheme is collected from normal user scenarios, and the volume analysis service 215 provides V(advised) to the volume control agent 214 for determining how to adjust the user's session volume. If the user makes a manual volume adjustment, then the scheme of this user will be updated automatically for storing the user preferences for future adjustments. It should be noted that, in some embodiments, location data may optionally be stored in the scheme as well. For example, for each background noise level, a separate speaker volume level may be recorded for home and office (e.g., 15% at office, 25% at home for 25 dB background noise, etc.). As such, the volume control module 214 may not only provide session volume adjustment for different audio devices 206 at different background noise levels, but also further adjust the session volumes based upon the particular location the client device 203 is being used. By way of example, location may be determined by an IP address from which the client device 203 is accessing the virtual computing session 205 in some embodiments. Other factors that may be used for identifying particular client devices 203 and/or their locations include different CWA client types, and whether a physical virtual machine (VM) or virtual machine is running, for example.

By way of example, for user johnz, at a first time N=40 db, D(client) is headphones, V(client) is 50%, and the database 216 includes the values set forth in Table 1 above. When there is a switch between audio devices 206, this switch is detected by the volume control agent 213, which triggers the volume control module 214 to reduce V(vda) to the protection value, which in the present example will be 8%. Furthermore, the background noise level N of the location or environment where the client device 203 is obtained by the associated audio input device. For example, N may be collected within a reasonable period (e.g., 3s) by the microphone of client device 203 that runs the CWA client 212, and it is then passed to the volume control module 214 and subsequently the volume analysis service 215. Based on N and D(client), which in the present embodiment are 40 dB and headphones, respectively, the volume analysis service 215 queries the database 216 to find johnz's V̅_{D=headphones,N=40 db}. As shown in Table 1, when N is 40 db, and johnz uses the headphones, the V(advised) should be 20%. Since V(client) is 50%, V(vda) should be V(advised)/V(client)=20%/50%=40%. Then the volume control module 214 will slowly turn V(vda) up (fade in) to 40%.

At some later time after the automated session volume adjustment is initiated by the volume control module 214, johnz manually turns V(client) to 45%, which means V(advised) may be a little louder. As such, the volume control agent 213 updates V(client), while the volume control module 214 updates V(vda) and calculates V(reference)=V(vda)*V(client)=40%*45%=18%, which the volume control module sends as a new V(reference)_{D=headphones,N=40 db} to the volume analysis service 215. It may then be averaged with previously stored V̅_{D=headphones,N=40 db} (within total times), and then johnz's V̅_{D=headphones,N=40 db} will be updated to a new value.

It should be noted that, while the present example was described with reference to a Citrix Workspace/Citrix Cloud implementation, the above-described approach may also be integrated into other virtualization computing platforms or environments as well in different embodiments. Moreover, it should be noted that in scenarios such as those shown in FIGS. 9A, 9B where a given user has multiple different client devices 203, the volume control module 214 (and indeed, volume control modules from different VDAs) can collect V(client), D(client), and N data from all of the different devices, and control the volume at all of the different devices as well, as they are connected to virtual computing sessions 205.

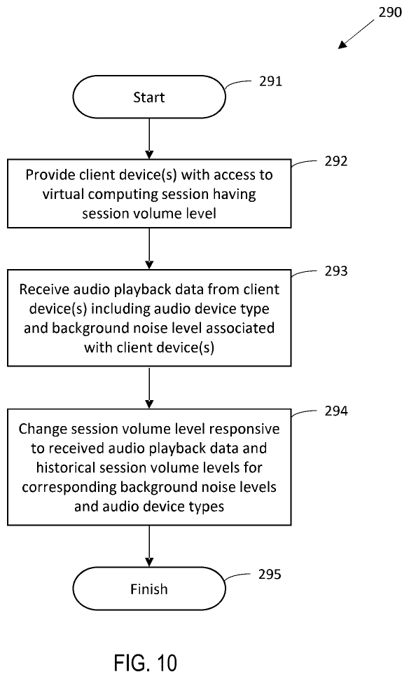

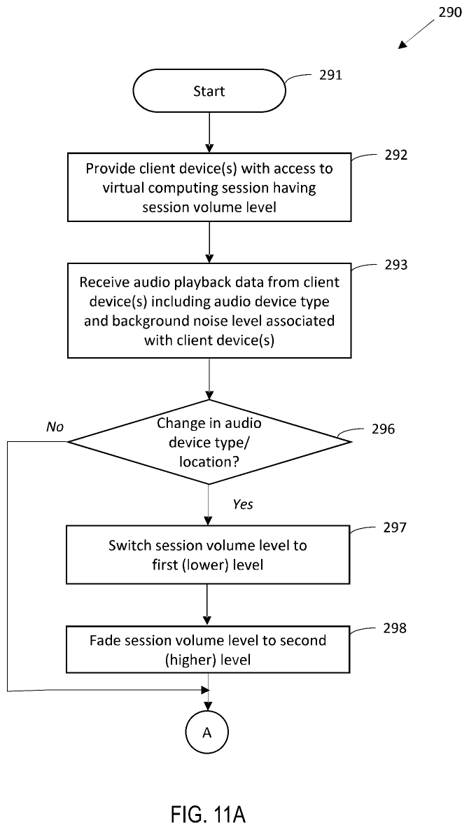

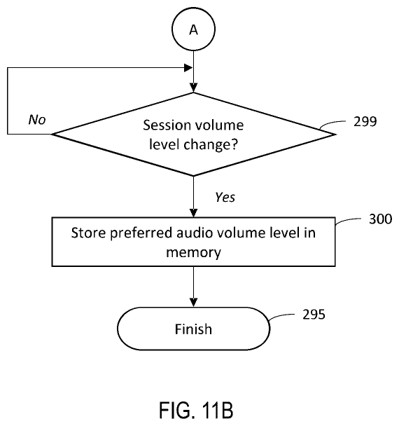

Turning to the flow diagram 290 of FIGS. 10 and 11A, 11B, related method aspects are now described. Beginning at Block 291, the processor 202 cooperates with the memory 201 to provide the client device(s) 203 with access to a virtual computing session 205 (e.g., SaaS, DaaS, etc.) having a session volume level associated therewith, at Block 292, and receives audio playback data from the client device(s) including the audio device type and background noise level (Block 293), as discussed further above. The processor 202 further changes the session volume level responsive to the received audio playback data and historical session volume levels (e.g., from the database 216) for corresponding background noise levels and audio device types associated with the client device(s) 203, at Block 294, which illustratively concludes the method of FIG. 10.

More particularly, the processor 202 may be configured to change the session volume level by switching the session volume level to a first (lower or protected) level, at Block 297, and then fading the session volume level in to a second level higher than the first level, at Block 298, as noted above. Moreover, changing of the session volume level may be triggered by or responsive to a change in the audio device 206 type and/or the client computing device 203 accessing the virtual computing session 205 from a different location (Block 296). Additionally, when the client device 203 makes a session volume change (e.g., manually) after the initial automatic adjustment (Block 299), the processor 202 may be further configured to communicate with the volume analysis service 215 to store and update the historical session volume levels for use next time an automatic session volume change is triggered, at Block 300.

Many modifications and other embodiments will come to the mind of one skilled in the art having the benefit of the teachings presented in the foregoing descriptions and the associated drawings. Therefore, it is understood that the foregoing is not to be limited to the example embodiments, and that modifications and other embodiments are intended to be included within the scope of the appended claims.

1. A computing device comprising:
a memory and a processor cooperating with the memory to:
provide at least one client device with access to a virtual computing session having a session volume level associated therewith;
receive audio playback data from the at least one client device including an audio device type and a background noise level associated with the at least one client device; and
change the session volume level responsive to the received audio playback data and historical session volume levels for corresponding background noise levels and audio device types associated with the at least one client device.

2. The computing device of claim 1 wherein the processor is configured to change the session volume level responsive to a change in the audio device type.

3. The computing device of claim 1 wherein the processor is configured to change the session volume level responsive to the at least one client computing device accessing the virtual computing session from a different location.

4. The computing device of claim 1 wherein the processor is further configured to change the session volume level by switching the session volume level to a first level, and then fading the session volume level in to a second level higher than the first level.

5. The computing device of claim 1 wherein the historical session volume levels also correspond to different locations.

6. The computing device of claim 1 wherein the processor is further configured to communicate with a volume analysis service to store and update the historical session volume levels.

7. The computing device of claim 1 wherein the at least one client device comprises a first client device at a first location and a second client device at a second location different than the first location, and wherein the processor receives the audio playback data from the first client device and changes the session volume level at the second client device.

8. A method comprising:
at a computing device:
providing at least one client device with access to a virtual computing session having a session volume level associated therewith;
receiving audio playback data from the at least one client device including an audio device type and a background noise level associated with the at least one client device; and
changing the session volume level responsive to the received audio playback data and historical session volume levels for corresponding background noise levels and audio device types associated with the at least one client device.

9. The method of claim 8 wherein changing comprises changing the session volume level responsive to a change in the audio device type.

10. The method of claim 8 wherein changing comprises changing the session volume level responsive to the at least one client computing device accessing the virtual computing session from a different location.

11. The method of claim 8 wherein changing comprises changing the session volume level by switching the session volume level to a first level, and then fading the session volume level in to a second level higher than the first level.

12. The method of claim 8 wherein the historical session volume levels also correspond to different locations.

13. The method of claim 8 wherein further comprising, at the computing device, communicating with a volume analysis service to store and update the historical session volume levels.

14. The method of claim 8 wherein the at least one client device comprises a first client device at a first location and a second client device at a second location different than the first location; wherein receiving comprises receiving the audio playback data from the first client device; and wherein changing comprises changing the session volume level at the second client device.

15. A non-transitory computer-readable medium having computer-executable instructions for causing a computing device to perform steps comprising:
providing at least one client device with access to a virtual computing session having a session volume level associated therewith;
receiving audio playback data from the at least one client device including an audio device type and a background noise level associated with the at least one client device; and
changing the session volume level responsive to the received audio playback data and historical session volume levels for corresponding background noise levels and audio device types associated with the at least one client device.

16. The non-transitory computer-readable medium of claim 15 wherein changing comprises changing the session volume level responsive to a change in the audio device type.

17. The non-transitory computer-readable medium of claim 15 wherein changing comprises changing the session volume level responsive to the at least one client computing device accessing the virtual computing session from a different location.

18. The non-transitory computer-readable medium of claim 15 wherein changing comprises changing the session volume level by switching the session volume level to a first level, and then fading the session volume level up to a second level higher than the first level.

19. The non-transitory computer-readable medium of claim 15 wherein the historical session volume levels also correspond to different locations.

20. The non-transitory computer-readable medium of claim 15 wherein the at least one client device comprises a first client device at a first location and a second client device at a second location different than the first location; wherein receiving comprises receiving the audio playback data from the first client device; and wherein changing comprises changing the session volume level at the second client device.
